(19) United States
(12) Patent Application Publication
(10) Pub. No.: US 2016/0178022 A1
(43) Pub. Date: Jun. 23, 2016

(54) Clover Leaf Hub

(71) Applicant: Caterpillar Inc., Peoria, IL (US)

(72) Inventors: Steven Troy McGee, Decatur, IL (US); Bradley Guy Kaufman, Oreana, IL (US); Bryan Dale Van Dyke, Mt. Zion, IL (US); Wesley Colton Worsham, Decatur, IL (US)

(73) Assignee: Caterpillar Inc., Peoria, IL (US)

(21) Appl. No.: 14/575,757

(22) Filed: Dec. 18, 2014

(51) Int. Cl. F16D 65/853; F16D 55/36

(52) U.S. Cl. CPC F16D 65/853; F16D 55/36

(57) ABSTRACT

A wet brake assembly and method for cooling separator plates in a wet brake assembly are disclosed. The wet brake assembly may comprise a hub rotatable about an axis and a brake pack. The hub may include a plurality of legs that define a plurality of troughs in the hub. The brake pack may include a plurality of friction disks disposed around and rotatable with the hub, and a plurality of stationary separator plates. Each separator plate may define a gap with at least one of the friction disks. Each trough may define an unobstructed axial flow path between the hub and the brake pack, and each gap may define a radial flow path across the brake pack. An intersection between the axial flow path and the radial flow path is configured to change positions with rotation of the hub and the friction disks.

### TECHNICAL FIELD

The present disclosure generally relates to wet brake assemblies of vehicles and, more particularly, relates to hubs associated with brake packs in wet brake assemblies used in earth moving, construction, material handling, mining vehicles, and the like.

### BACKGROUND

Wheel housings, axle housings, housings associated with tandem drive assemblies, or the like, of vehicles used for earth moving, construction, material handling, and mining applications are typically partially filled with fluid for cooling and lubricating components contained in the housing. It is desirable to have a flow of fluid over components to provide a medium for heat transfer and heat dissipation in order to lengthen component life-span and avoid undesirable effects that may occur from overheating of such components. It is also desirable to have a film of oil between contacting components in order to avoid extreme heat that may otherwise be created during contact. Such extreme heat may cause, between contacting surfaces, micro-welding that results in tearing and pitting of the surfaces and shorter life-spans of the components due to material fatigue.

Such housings may contain an axle shaft that drives a ground engaging member as well as an annular hub of a wet brake assembly. The outer circumference of the annular hub may be splined to lockingly mesh with rotatable components of a brake pack. While brake packs typically include a plurality of separator plates interleaved with a plurality of friction disks, usually only one or the other of these components rotate with the hub. For example, the plurality of annular friction disks may rotate with the hub and the plurality of separator plates may be stationary.

In order to lockingly mesh the hub and rotating components of the brake pack, the spaces between the circumferentially-spaced teeth of the rotating components, for example the friction disks, are substantially filled by the “teeth” of the hub spine. To reach the gaps between each friction disk and separator plate, cooling fluid must first seep in the axial direction through the small sliver of space between the meshed teeth of each friction disk and the spline of the hub. Alternatively, some fluid at or below the fluid level in the lower half of the housing may be picked up by the friction disks as they rotate through the “pooled” fluid. Since the separator plates do not rotate through the fluid in the lower half of the housing, the portion of the separator plates that are disposed in the upper half of the housing do not receive the same amount of cooling fluid and lubrication as the portion of the separator plates that are bathed in fluid due to their position in the lower half of the housing. This may result in an uneven cooling of the separator plates.

U.S. Publication No. 2013/0180809 (“Yabuuchi et al.”) published Jul. 18, 2013 discloses a rotating side brake disk stacked with frictional non-rotating side brake disks utilized to brake the swing circle of the body of an excavator, or the like, as it revolves around a lower traveling structure. There is a plurality of through holes in the rotating side brake disk in the area where it does not make contact with the frictional material of the non-rotating side disk. According to the disclosure, oil introduced at the outer circumference of the brake pack flows from the outer circumference through oil grooves to the holes and from there upward toward the oil lubricant outlet port. While this design may provide benefits for an application in which the rotating side brake disk moves intermittently or relatively infrequently, it would not provide appropriate cooling and lubrication for an application in which the rotating side brake(s) is rotating for a relatively long period of time because the centrifugal force on the fluid generated by such disk(s) would provide a counteracting force that inhibits or prevents the oil from moving from the outer circumference toward the inner circumference, which would diminish the ability of the Yabuuchi et al. design to effectively lubricate or cool the brake pack when the machine is moving. A better design is needed.

### SUMMARY OF THE DISCLOSURE

In accordance with one aspect of the disclosure, a wet brake assembly is disclosed. The wet brake assembly may comprise a hub rotatable about an axis and a brake pack. The hub may include a plurality of legs. The plurality of legs may define a plurality of troughs. The brake pack may include a plurality of annular friction disks disposed around the hub, and a plurality of stationary separator plates. Each friction disk may be rotatable with the hub. Each separator plate may define a gap with at least one of the friction disks. Each trough of the hub may define a substantially unobstructed axial flow path between the hub and the brake pack. Each gap may define a radial flow path across the brake pack. An intersection between the axial flow path and the radial flow path is configured to change positions with rotation of the hub and the friction disks.

In accordance with another aspect of the disclosure, a method for cooling separator plates in a wet brake assembly is disclosed. The wet brake assembly may comprise a hub rotatable about an axis, and a brake pack. The hub may include a plurality of legs that define a plurality of troughs. The brake pack may include a plurality of friction disks disposed around and rotatable with the hub, and a plurality of stationary separator plates, each separator plate defining a gap with at least one of the friction disks. Each trough may define a substantially unobstructed axial flow path between the hub and the brake pack, and each gap may define a radial flow path across the brake pack. An intersection between the axial flow path and the radial flow path is configured to change positions with rotation of the hub and the friction disks. The method may comprise rotating the hub and the axial flow path, using the legs of the rotating hub to generate centrifugal force on the fluid flowing through the axial flow path by spinning the fluid around the axis, depositing fluid from the rotating axial flow path into the radial flow path, and cooling the separator plates by using the centrifugal force acting on the fluid and the rotation of the friction disks to spread the fluid received from the axial flow path over the separator plates.

In accordance with a further aspect of the disclosure, a wet brake assembly disposed inside a wheel housing on a vehicle is disclosed. The vehicle may include an axle shaft operably connected to a ground engaging member. The vehicle may include an axle shaft operably connected to a ground engaging member. The wet brake assembly may comprise a hub including a plurality of legs, and a brake pack. The plurality of legs may define a plurality of troughs. The hub is rotatable about the axle shaft when the axle shaft rotates the ground engaging member. The axle shaft defines an axis about which the hub is rotatable. The brake pack includes a plurality of annular friction disks disposed around the hub, each friction disk rotatable with the hub, and a plurality of stationary separator plates, each separator plate defining a gap with at least one of the friction disks. Each trough of the hub defines a substantially unobstructed axial flow path between the hub and the brake pack. Each gap defines a radial flow path across the brake pack. An intersection between the axial flow path and the radial flow path is configured to change positions with rotation of the hub and the friction disks.

### BRIEF DESCRIPTION OF THE DRAWINGS

FIG. 1 is a sectional view of an exemplary wheel housing with the brake pack of the wet brake assembly in a compressed state;

FIG. 2 is a perspective view of the exemplary wheel housing of FIG. 1 with the sprocket and brake cover removed;

FIG. 3 is another sectional view the wheel housing;

FIG. 4 is a perspective view of an exemplary vehicle that incorporates the wet brake assembly of this disclosure;

FIG. 5 is a top view of a hub;

FIG. 6 is a side view of the hub of FIG. 5;

FIG. 7 is an enlarged detail view of a portion of FIG. 1 with the brake cover removed and the brake pack of the wet brake assembly in an uncompressed state; and

FIG. 8 is a flowchart depicting a sample sequence of steps which may be practiced in accordance with an exemplary method employing the teachings of the present disclosure.

### DETAILED DESCRIPTION

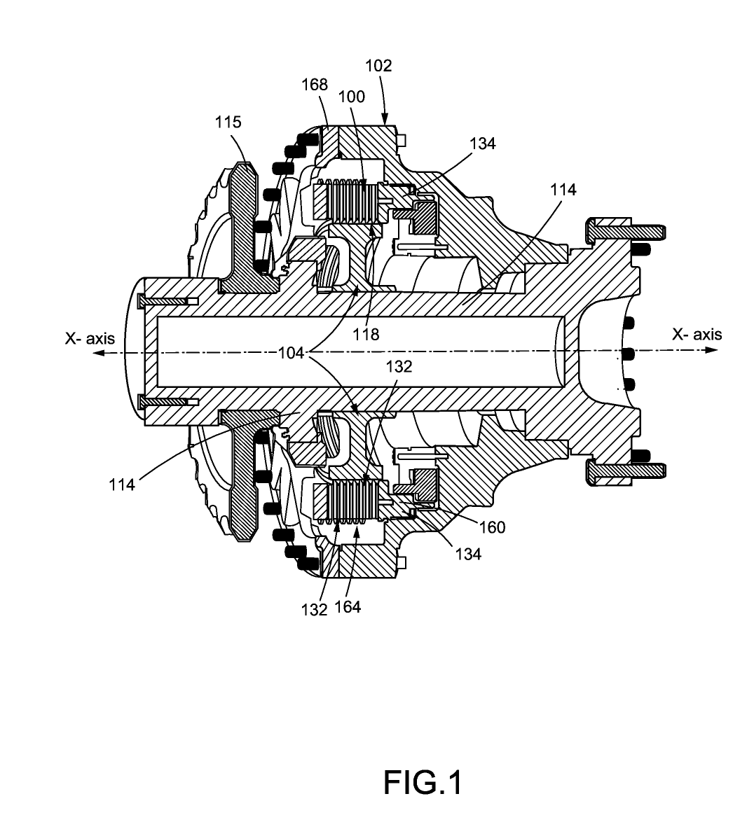

Referring now to the drawings, and with specific reference to FIGS. 1-3, there is shown a wet brake assembly disposed in a wheel housing 102. The wet brake assembly is constructed in accordance with the present disclosure and generally referred to by reference numeral 100.

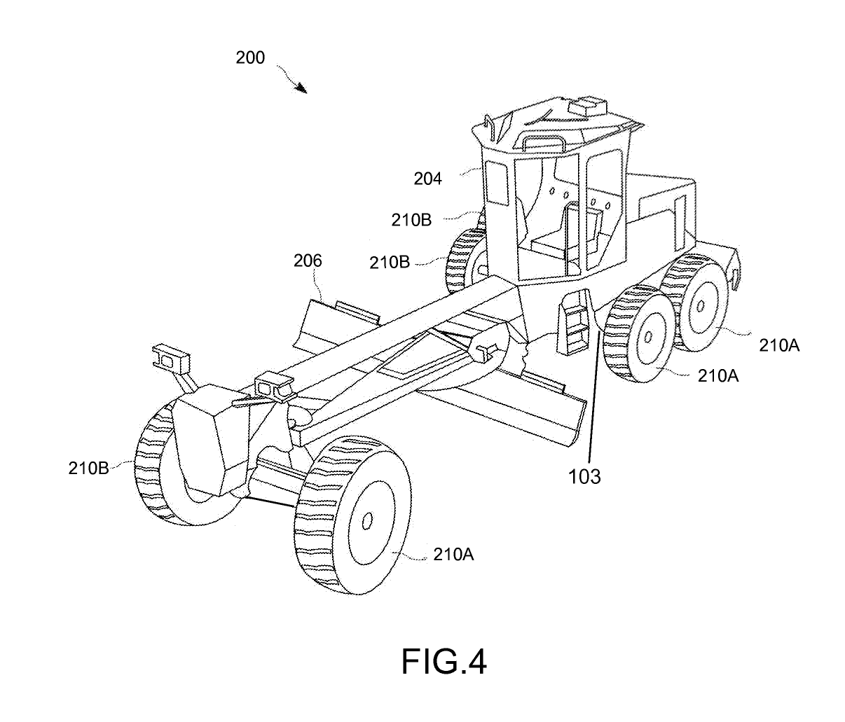

FIG. 4 illustrates one example of a machine 200 that incorporates the features of the present disclosure. The machine 200 may be a mobile vehicle that performs one or more operations associated with an industry such as earth moving, construction, fanning, mining or any other industry known in the art. In the illustrated embodiment, the machine 200 is a motor grader. While the following detailed description and drawings are made with reference to a wet brake assembly 100 (FIGS. 1-3) in a wheel housing 102 of a motor grader, the teachings of this disclosure may be employed on other earth moving, construction, fanning or mining machines in which wet brakes are used in housings, or the like, partially filled with oil or other cooling or lubricating fluid.

In the illustrated embodiment, the machine 200 includes a power source such as an engine (not shown), an operator station or cab 204 containing input devices and operator interfaces for operating the machine 200, and a work tool or an implement 206, such as a blade. The input devices may include one or more devices disposed within the cab 204 and may be configured to receive inputs from the operator. The inputs may be indicative of controlling propulsion of the machine 200, operation of the implement 206, braking of the machine 200 and/or other operations of the machine 200.

The machine 200 may include a first set of ground engaging members 210A on one side of the machine 200 and a second set of ground engaging members 210B on other side of the machine 200. For example, the first and second set of ground engaging members 210A, 210B may be on a left side and a right side of the machine 200. The first set of ground engaging members 210A and the second set of ground engaging members 210B may be adapted for steering and maneuvering the machine 200, and for propelling the machine 200 in forward and reverse directions. In the illustrated embodiment in FIG. 4, the first and second set of ground engaging members 210A, 210B are wheels. However, in an alternative embodiment, the first and second set of ground engaging members 210A, 210B may include track assemblies.

In the embodiment illustrated by FIG. 4, pairs of first and second ground engaging members 210A, 210B may be operatively connected by a tandem drive assembly 103. In one embodiment, such tandem drive assembly 103 may include a pair of wheel housings 102 disposed on opposite ends. In each wheel housing 102, the wet brake assembly 100 may be disposed. Each wet brake assembly 100 is operatively connected to a first or a second ground engaging member 210A/210B.

The tandem drive assembly 103 may further include a differential (not shown) and a pair of axle shafts 114. Each axle shaft 114 (FIGS. 1-3) is disposed on an opposite side of the differential and operatively connects the differential to the wet brake assembly 100. The wet brake assembly 100 may be disposed between the differential and the ground engaging member(s) 210A/210B. More specifically, in one embodiment, the wet brake assembly 100 may be disposed, inside a wheel housing 102, between the sprocket 115 (of the final drive and chain arrangement) and the ground engaging member 210A/210B. In other embodiments, the wet brake assembly 100 may be disposed after the differential but before the sprocket 115 (for the final drive and chain arrangement) and the ground engaging member 210A/210B, and may be contained in a housing other than the wheel housing 102. The rotation of the axle shaft 114 drives the ground engaging member(s) 210a/210B (FIG. 4) to which it is operably connected via the wet brake assembly 100 (FIG. 1-3).

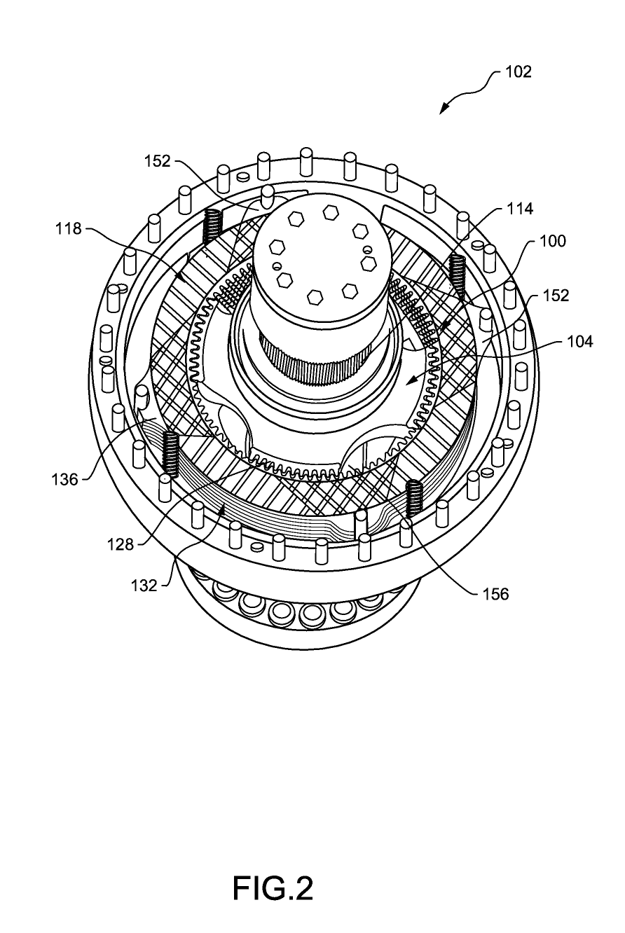

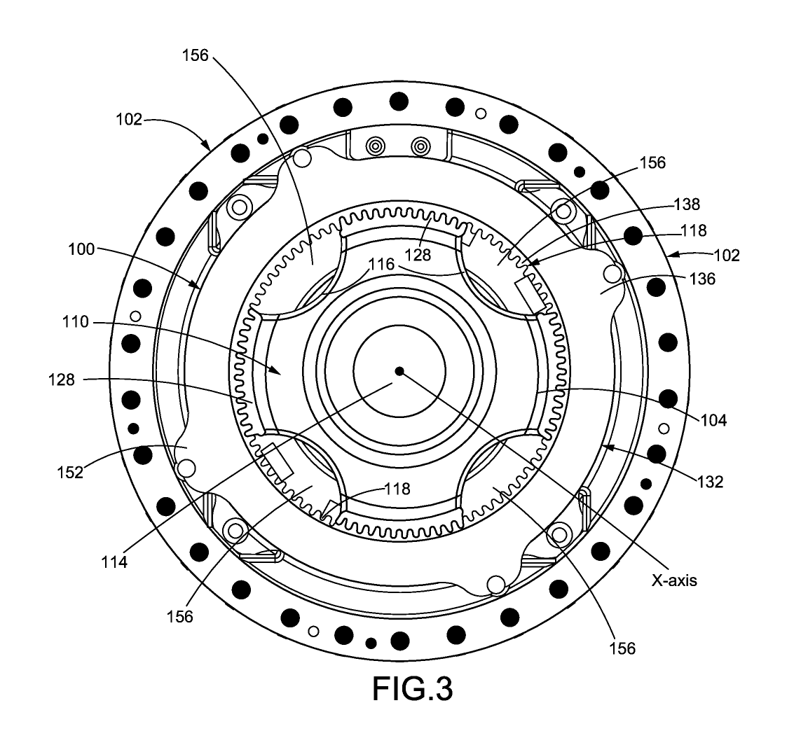

FIGS. 1-3 illustrate an exemplary wet brake assembly 100. The wet brake assembly 100 is disposed inside a housing. For example, in FIGS. 1-3, the wet brake assembly 100 is disposed inside the wheel housing 102. In FIGS. 2-3, the sprocket 115 and brake cover 168 have been removed so that the wet brake assembly 100 may be viewed more clearly. The wet brake assembly 100 comprises a rotatable hub 104 and a brake pack 132. The wet brake assembly 100 may further comprise a piston 134.

Hubs are generally meshed with a plurality of friction disks contained in a brake pack of a brake assembly. The hub traditionally has an annular shape that closely reciprocates the contour of the inner circumference of the meshed annular friction disks in order to adequately provide the substantial locking contact with the friction disks that is necessary to rotate the friction disks without unacceptable slip and to allow the friction disks to stop/brake the rotation of the hub without unacceptable slip.

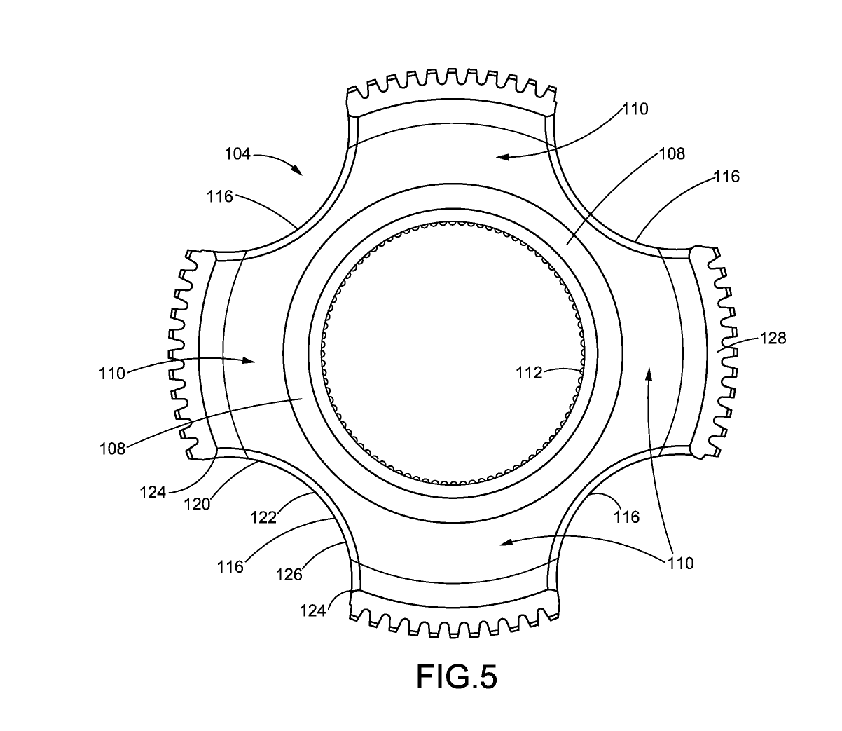

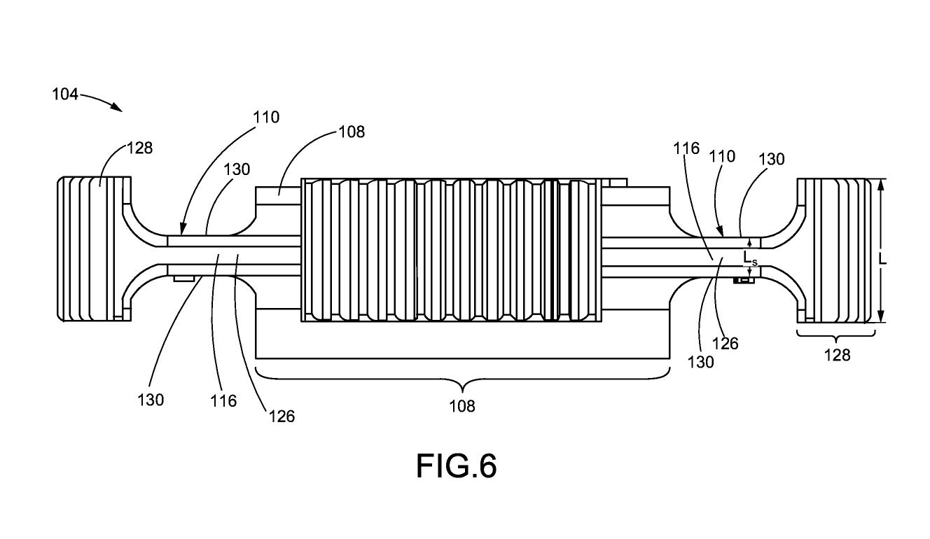

FIGS. 5-6 illustrate a novel hub 104. As disclosed herein, the hub 104 includes a body 108, and a plurality of legs 110. The body 108 may be generally cylindrical in shape with an inner surface 112. The inner surface 112 may be splined. This inner surface 112 receives the axle shaft 114 (FIGS. 1-3). The axle shaft 114 rotates about a center X-axis and, in doing so, rotates the hub 104 about the center X-axis.

Each of the legs 110 extend radially outward from the body 108. The plurality of legs 110 define a plurality of troughs 116 (best seen in FIGS. 3 and 5) disposed between the outward extending legs 110. The troughs 116 represent cut-outs from the annular shape of a traditional hub. Each trough 116 has a sidewall 126 (FIG. 6) extending in the axial direction. The axial direction is a direction that is generally parallel to the X-axis about which the axle shaft 114 rotates. In one embodiment, the perimeter 120 (of each sidewall 126) (FIG. 5) of the trough 116 has a curved contour with the midpoint 122 of the perimeter 120 closest to the body 108 of the hub 104, relative to the ends 124 of the perimeter 120 of the trough 116. In one embodiment, the sidewall 126 (FIG. 6) of the trough 116 may be free of splines. Each trough 116 defines an axial flow path 156 (best seen in FIGS. 2-3) between the hub 104 and the brake pack 132. Such axial flow path 156 extends in the axial direction and flow within it is unobstructed by the friction disks 118 or the separator plates 136 of the brake pack 132.

Each leg 110 includes an interface 128 (best seen in FIGS. 3 and 5-6) extending in an axial direction (generally parallel to the X-axis and the axle shaft 114). In one embodiment, the interface 128 may be splined. In an embodiment, the length L (FIG. 6) of the interface 128 in the axial direction may be substantially greater than the length L_{S} of the sidewall 126 of the trough 116 in the axial direction.

In FIGS. 3 and 5, four evenly-spaced legs 110 are illustrated. In other embodiments, there may be a greater or fewer quantity of legs 110, and the angular position of each leg 110 in relation to the body 108 may be different, as long as the combination of the positioning and the total number of legs 110 provides the necessary force to rotate the friction disks 118 (FIG. 3), substantially without slip, while providing generally even cooling of the separator plates 136 (as will be discussed later), and has the necessary strength to stop the rotation of the hub 104 and axle shaft 114 (substantially without slip) when braking force is applied via the brake assembly 106.

Each leg 110 has first and second side surfaces 130 (FIG. 6) extending radially outward from the body 108. The contour of the side surfaces 130 of the legs 110 may be partially curved.

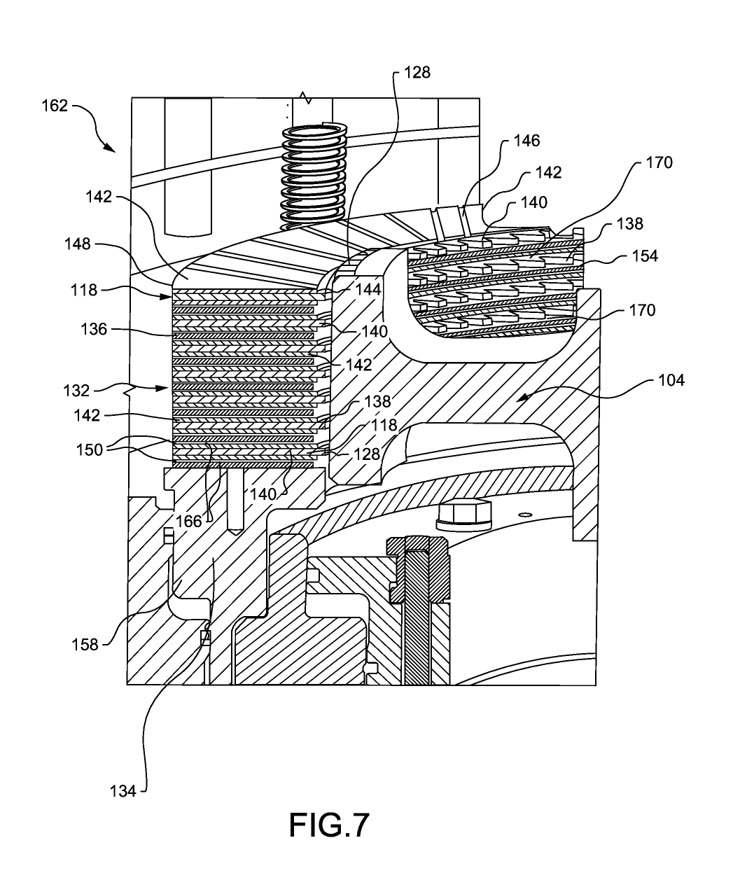

Turning now to FIGS. 1 and 7 (an enlarged portion of FIG. 1 with the brake cover 168 removed), the brake pack 132 includes a plurality of annular friction disks 118 and a plurality of generally annular separator plates 136, each disposed about the X-axis. One of such components is typically rotatable with the hub 104. For example, in one embodiment, the friction disks 118 may be rotatable with the hub 104 and the separator plates 136 may be stationary.

In the illustrated embodiment, each friction disk 118 is disposed around the hub 104 and has a toothed inner circumference 138 that receives the hub 104 and lockingly meshes with each splined interface 128 of the hub 104 (best seen in FIG. 3). Each friction disk 118 includes a core 140 (FIG. 7) sandwiched between friction members 142. The friction members 142 are made of a material that resists movement when compressed against another surface (for example, the surface of the separator plate 136). Some or all of the friction members 142 may include grooves 146 that are recessed into the friction members 142 and extend between the axial flow path 156 (adjacent to the friction member inner circumference 144) and the friction member outer circumference 148.

Each separator plate 136 is disposed adjacent to, and defines a gap 150 with, at least one friction disk 118. Each gap 150 is a radial flow path 166 that encircles the X-axis. The bounds of the radial flow path 166 may physically extend in the radial direction over the surfaces of the separator plate 136 and the friction disk 118 (of the brake pack 132) however fluid moving within the radial flow path 166 may move or spread in the radial direction (outward from the X-axis), in a direction around the X-axis and/or in another direction. Each separator plate 136 may have an annular rim 154 disposed around the hub 104. In an embodiment, the separator plates 136 may be mounted to the wheel housing 102 via a tabbed portion 152 (FIGS. 2-3) of the separator plate 136.

The brake pack 132 has a compressed state 164 and an uncompressed state 162. The compressed state 164 is best seen in FIG. 1. The uncompressed state 162 is best seen in FIG. 7. In the uncompressed state 162 the friction disks 118 rotate with the hub 104 and the radial flow path 166 is open (not blocked by the separator plates 136 and the friction disks 118).

The piston 134 may be disposed adjacent to the brake pack 132 and may be moveable from a released position 158 (FIG. 7) to an applied position 160 (FIG. 1). In the released position 158 (FIG. 7), the piston 134 is retracted and the brake pack 132 is in, or moves to, the uncompressed state 162. As noted above, in this state the friction disks 118 are free to rotate with the hub 104. In the uncompressed state 162 when the hub 104 and the friction disks 118 are rotating together, an intersection 170 between the axial flow path 156 and the radial flow path 166 changes circumferential positions (locations) along the rim 154 of the generally annular stationary separator plates 136.

In the applied position 160 (FIG. 1), the piston 134 is extended. The extension of the piston 134 moves the brake pack 132 into the compressed state 164 by apply a force on the brake pack 132 that moves or compresses, in the axial direction, the separator plates 136 and the friction disks 118 against each other and against the brake cover 168. In the compressed state 164, the hub 104 and the friction disks 118 are generally stationary and the radial flow path 166 is blocked or interrupted by the movement of the separator plates 136 and the friction disks 118 together. Movement of the brake pack 132 to the compressed state 164 slows and eventually stops the hub 104 from rotating. This, likewise, slows and eventually stops the axle shaft 114 from rotating and thereby provides a braking force on the corresponding set of ground engaging members 210A/210B to which the axle shaft 114 is operably connected. The braking force may slow the machine 200 or prevent the machine 200 from moving.

### INDUSTRIAL APPLICABILITY

A housing, for example the wheel housing 102, contains an amount of fluid (for example, oil or the like) that provides cooling and lubrication for the various parts within the housing (wheel housing 102), including the separator plates 136 and the friction disks 118. The present disclosure may find applicability in providing even cooling to the separator plates 136, especially after braking.

When the machine 200 is moving, the axle shaft 114 rotates about the X-axis. The axle shaft 114 rotates the hub 104. In one embodiment, the hub 104 rotates the friction disks 118 with which the hub 104 is meshed and the separator plates 136 remain stationary.

The axial flow paths 156 defined by the troughs 116 of the hub 104 rotate around the axis of rotation (namely, the X-axis) of the axle shaft 114. Fluid within the wheel housing 102 flows into the axial flow paths 156 where the rotating legs 110 push/spin the fluid around the X-axis, thus generating centrifugal force acting on the fluid. The axial flow paths 156 are completely unobstructed by the friction disks 118 or the separator plates 136 which allows a substantial amount of fluid to move axially through the axial flow paths 156.

The fluid, acted upon by centrifugal force, is deposited by the rotating axial flow paths 156 into each radial flow path 166 between each of the friction disks 118 and separator plates 136 where it spreads over the separator plates 136 and friction disks 118 both radially outward and tangentially to the direction of the centrifugal force. Some of the fluid in the radial flow paths 166 is also moved in a direction around the X-axis by the rotation of the friction disks 118 (one of the boundaries of the radial flow path 166). The grooves 146 in the friction disks 118 also help distribute fluid in the radial flow path 166. The fluid in the radial flow path 166 provides lubrication and cooling of the friction disks 118 and the separator plates 136.

In order to slow or stop the movement of the vehicle 200, the piston 134 compresses the friction disks 118 against the interleaved separator plates 136 and against the brake cover 168. More specifically, when braking force is applied, the piston 134 forces the rotating friction disks 118 against the stationary separator plates 136 until the friction disks 118, the hub 104 and the axle 114 shaft slow their rotation or no longer rotate. The frictional contact between the friction disks 118 and the separator plates 136 generates heat that needs to be dissipated from the separator plates 136 and from the friction disks 118. After stopping the rotation of the hub 104 (and vehicle 200), fluid may seep from some axial flow paths 156 (those submerged in fluid contained or captive to the wheel housing 102) into the grooves 146. Some heat may transfer from the friction disks 118 and separator plates 136 into the fluid in the grooves 146. However, the longevity of part-life substantially benefits from the cooling provided while the braking (movement of the piston 134 toward the applied position 160) slows the vehicle 200 and once the piston 134 is moved to the released position 158 and the vehicle 200 is moving again.

Once the braking force is removed, the piston 134 is retracted into the released position 158 and the brake pack 132 moves to the uncompressed state 162. When the vehicle 200 begins moving again, the hub 104 and the friction disks 118 begin to rotate as well as the axial flow paths 156 defined by each of the troughs 116 of the hub 104. The rotating legs 110 spin the fluid around the X-axis and the fluid, acted upon by centrifugal force, is deposited by the rotating axial flow path 156 into the radial flow path 166 between each friction disk 118 and separator plate 136 where it absorbs the heat dissipated from the separator plates 136 and friction disks 118 and flows out of the radial flow path 166 (near the friction member outer circumference 148) and into the wheel housing 102. Such heat exchange cools the friction plates 118 and provides for even cooling of the separator plates 136 because the entry point of the fluid (intersection 170) into the radial flow paths 166 rotates around the rims 154 of the separator plates 136 and fluid entry into the radial flow paths 166 is not substantially obstructed by the meshing of the hub 104 with the friction disks 118.

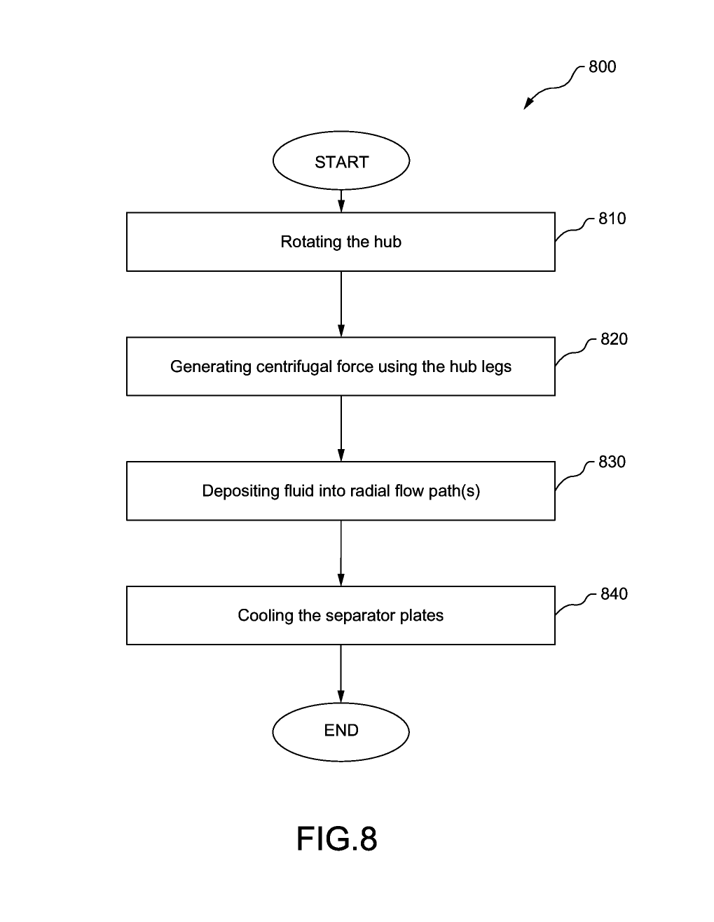

Referring now to FIG. 8, an exemplary method 800 is illustrated showing sample blocks that may be followed in the method for cooling separator plates 136 in the wet brake assembly 100 disposed inside a housing, such as a wheel housing 102 that contains fluid. The method 800 may be practiced with more or less than the number of blocks shown.

The wet brake assembly 100 may comprise a hub 104 rotatable about an axis (X-axis) and a brake pack 132. The hub 104 may include a plurality of legs 110 that define a plurality of troughs 116 in the hub 104. The brake pack 132 may include a plurality of friction disks 118 disposed around and rotatable with the hub 104, and a plurality of stationary separator plates 136. Each separator plate 136 may define a gap 150 with at least one of the friction disks 118. Each trough 116 may define an unobstructed axial flow path 156 between the hub 104 (along the entire axial length L_{S} of the sidewall 126) and (the entire axial length of) the brake pack 132, and each gap 150 may define a radial flow path 166 across the brake pack 132. An intersection 170 between the axial flow path 156 and the radial flow path 166 is configured to change positions with rotation of the hub 104 and the friction disks 118.

The process includes, in block 810, rotating the hub 104 and the axial flow path 156 and, in block 820, using the legs 110 of the rotating hub 104 to generate centrifugal force on the fluid flowing through the axial flow path 156 by spinning the fluid around the X-axis.

The process further includes, in block 830, depositing fluid from the rotating axial flow path 156 into the radial flow paths 166.

The process further includes, in block 840, cooling the separator plates 136 by using the centrifugal force acting on the fluid and the rotation of the friction disks 118 to spread the fluid received from the axial flow path 156 over the separator plates 136.

The features disclosed herein may be particularly beneficial to motor graders and other earth moving, construction, mining or material handling vehicles 200 that utilize brake pack 132 components that rotate with hubs 104 driven by axle shafts 114 operably connected to ground engaging members 210A, 210B.

What is claimed is:

1. A wet brake assembly comprising:
a hub including a plurality of legs, the plurality of legs defining a plurality of troughs, the hub rotatable about an axis; and
a brake pack including:
a plurality of annular friction disks disposed around the hub, each friction disk rotatable with the hub; and
a plurality of stationary separator plates, each separator plate defining a gap with at least one of the friction disks,
wherein each trough of the hub defines a substantially unobstructed axial flow path between the hub and the brake pack, and each gap defines a radial flow path across the brake pack, an intersection between the axial flow path and the radial flow path configured to change positions with rotation of the hub and the friction disks.

2. The wet brake assembly of claim 1, in which each leg includes a splined interface and each friction disk has a toothed inner circumference lockingly meshed with each interface.

3. The wet brake assembly of claim 2, in which each separator plate has an annular inner rim disposed around the hub.

4. The wet brake assembly of claim 2, in which the interface has a first length in an axial direction, and at least one of the troughs includes a sidewall having a second length in the axial direction, wherein the first length is substantially greater than the second length.

5. The wet brake assembly of claim 4, wherein the sidewall has a curved contour.

6. The wet brake assembly of claim 4, wherein the sidewall is free of splines.

7. The wet brake assembly of claim 1, wherein each friction disk includes a core sandwiched between a pair of friction members, each friction member including a plurality of recessed grooves extending between the axial flow path and an outer circumference of the friction disk.

8. The wet brake assembly of claim 1, wherein the brake pack has an uncompressed state and a compressed state, when in the compressed state the hub and friction disks are stationary and the radial flow path is at least partially interrupted by the separator plates and the friction disks.

9. A method of cooling separator plates in a wet brake assembly, the wet brake assembly comprising a hub rotatable about an axis and a brake pack, the hub including a plurality of legs that define a plurality of troughs, the brake pack including a plurality of friction disks disposed around and rotatable with the hub, and a plurality of stationary separator plates, each separator plate defining a gap with at least one of the friction disks, wherein each trough defines a substantially unobstructed axial flow path between the hub and the brake pack, and each gap defines a radial flow path across the brake pack, wherein further an intersection between the axial flow path and the radial flow path is configured to change positions with rotation of the hub and the friction disks, the method comprising:
rotating the hub and the axial flow path;
using the legs of the rotating hub to generate centrifugal force on the fluid flowing through the axial flow path by spinning the fluid around the axis;
depositing fluid from the rotating axial flow path into the radial flow path; and
cooling the separator plates by using the centrifugal force acting on the fluid and the rotation of the friction disks to spread the fluid received from the axial flow path over the separator plates.

10. The method of claim 9, wherein the separator plates are cooled generally evenly.

11. The method of claim 9, in which each leg includes a splined interface and each friction disk has a toothed inner circumference lockingly meshed with each interface.

12. The method of claim 11, in which the interface has a first length in an axial direction, and at least one of the troughs includes a sidewall having a second length in the axial direction, wherein the first length is substantially greater than the second length.

13. The method of claim 12, wherein the sidewall is free of splines.

14. The method of claim 9, further comprising lubricating the friction disks and the separator plates by using the centrifugal force acting on the fluid and the rotation of the friction disks to spread the fluid received by the radial flow path from the axial flow path.

15. A wet brake assembly disposed inside a wheel housing on a vehicle, the vehicle including an axle shaft operably connected to a ground engaging member, the wet brake assembly comprising:
a hub including a plurality of legs, the plurality of legs defining a plurality of troughs, the hub rotatable about the axle shaft when the axle shaft rotates the ground engaging member, the axle shaft defining an axis about which the hub is rotatable; and
a brake pack including:
a plurality of annular friction disks disposed around the hub, each friction disk rotatable with the hub; and
a plurality of stationary separator plates, each separator plate defining a gap with at least one of the friction disks,
wherein each trough of the hub defines a substantially unobstructed axial flow path between the hub and the brake pack, and each gap defines a radial flow path across the brake pack, an intersection between the axial flow path and the radial flow path configured to change positions with rotation of the hub and the friction disks.

16. The wet brake assembly of claim 15, in which each leg includes a splined interface and each friction disk has a toothed inner circumference lockingly meshed with each interface.

17. The wet brake assembly of claim 16, in which each separator plate has an annular inner rim disposed around the hub.

18. The wet brake assembly of claim 16, in which the interface has a first length in an axial direction, and at least one of the troughs includes a sidewall having a second length in the axial direction, wherein the first length is substantially greater than the second length.

19. The wet brake assembly of claim 15, wherein each friction disk includes a core sandwiched between a pair of friction members, each friction member including a plurality of recessed grooves extending between the axial flow path and an outer circumference of the friction disk.

20. The wet brake assembly of claim 15, wherein the brake pack has an uncompressed state and a compressed state, when in the compressed state the hub and friction disks are stationary and the radial flow path is at least partially interrupted by the separator plates and the friction disks.
